(19) United States
(12) Patent Application Publication
(10) Pub. No.: US 2008/0162876 A1
(43) Pub. Date: Jul. 3, 2008

(54) DEDICATED HARDWARE PROCESSOR FOR STRUCTURED QUERY LANGUAGE (SQL) TRANSACTIONS

(75) Inventors: AKRAM A. BOU-GHANNAM, LAKE WORTH, FL (US); ROBERT A. HOTH, ROCHESTER, MN (US); JOHN W. MILLER, SUWANEE, GA (US); JOAQUIN RAMIREZ, FREMONT, CA (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/617,584

(22) Filed: Dec. 28, 2006

(51) Int. Cl. G06F 15/76

(52) U.S. Cl. 712/34; 712/E09.003

(57) ABSTRACT

The present solution can include a SQL coprocessor. The SQL coprocessor can comprise silicon-based logic within which a set of machine-readable instructions that are associated with one or more silicon-based components of a database architecture can be implemented. A silicon-based component can include a protocol interface component, a SQL parsing component, a calculation engine component, and/or an I/O handing component.

### BACKGROUND

1. Field of the Invention

The present invention relates to the field of databases and, more particularly, to a dedicated hardware processor for performing structured query language (SQL) transactions.

2. Description of the Related Art

Databases are organized data stores that permit users to store, update, delete, and search related information. A common language used by databases is the Structured Query Language (SQL),, such as the American National Standards Institute (ANSI) SQL-92 based language. As the size of a searchable database increases, a speed at which this space can be manipulated generally decreases. At a certain point, performance can degrade below an acceptable threshold, which has resulted in numerous technological tricks designed to improve performance in one manner or another.

One example of this Web search engines, which use database technologies to index content in millions of Web pages and to present appropriate ones of these pages to users responsive to queries. Users expect a relatively rapid response (i.e., within a few seconds) even though the search space is enormous and the search criteria can highly complex. Compromises are made with respect to indexing breadth, depth, algorithms utilized, mathematical operations permitted (i.e., most conventional Web search engines do not recognize parenthesis, which, if recognized, would constrain an order of operations), and the like to ensure this demanded performance is generally achieved. Thus, user interfaces are generally not granted access to pure SQL operations and functions. Further, the actual search space used for processing user queries can be an optimized space, not strictly adhering to ANSI SQL-92 language standards. Any optimized search space that has been tailored to accelerate Web-based searching is automatically generated from a more robust SQL-based search space, which periodically and automatically generates the optimized search space from a SQL-based space. Thus, current Web search engines use a hybrid solution, which is based upon a SQL database backbone to improve performance.

Another, more traditional, database example is a management information system (MIS) database for an enterprise, which can relate customers, employees, projects, products, prices, inventory, costs, historical purchasing information, and other important attributes. An authorized administrator is then able to construct queries that help provide information that is helpful for making business decisions. For example, an administrator can query the database to construct a report showing monthly profits by sales region, highlighting the top N and bottom M number of sales people per region. Such a report can be used for promotion and/or reduction in force purposes. Assuming a produced product is provided in different colors, the same database can be queried to determine sa sales volume for a product by color compared to a total sales volume of the product, which is organized by region. Results from this query can be used to establish manufacturing and distribution parameters for the product that are based upon market preferences, which should lead to greater sales. These examples are meant to emphasize that SQL is a powerful and robust language for database manipulation and that overall performance when performing SQL operations can be critical.

FIG. 1 is a schematic diagram showing a prior art database architecture 100. The architecture 100 shows both software 105 and hardware 130 layers. The software layer 105 includes a protocol interface 110, which interacts with a SQL parser 115 component. The SQL parse 115 interfaces with a calculation engine 120, which generally performs lambda calculus. The calculation engine 120 interfaces with an I/O to storage 125 component. This component 125, in turn, accesses memory 135 in the hardware layer 130. Processing operations performed by each of the software components 110-125 are routed through normal layers of the operating system, where the processing is ultimately performed by a general purpose processing unit 140, such as the Central Processing Unit (CPU) of a database server.

Overall, processing speeds and performance for the architecture 100 is limited by the performance of the software components 110-125. Despite attempts to optimize indexing, to optimize software components 110-125 for a particular platform, and to gain performance through various other forms of technology-based trickery, fundamental performance boundaries remain. These performance boundaries have begun forcing hybrid solutions, such as those described above for Web-based searches, which are not pure SQL solutions and which limit user accessible searching operations to a subset of the available ones, all for performance reasons. Hybrid solutions can be extremely costly in terms of computing resource consumptions and can be prohibitively expensive for most businesses to create, administer, and maintain. What is needed is a means to improve SQL processing performance without distorting a data framework, without constraining user-accessible SQL operations, and without incurring additional resource and personnel overhead.

### SUMMARY OF THE INVENTION

The present invention discloses a solution of a dedicated SQL hardware processor. The specialized processor (e.g., a coprocessor) can be used to progressively replace common database components with silicon-based logic that will replace and greatly speed up ANSI SQL transactions regardless of a utilized database engine. The database engine used with the disclosed solution can include, but is not limited to, DB2, ORACLE, SYBASE, MYSQL, POSTGRESQL, and other Relational Database Management System (RDBMS) engines. Any combination of software components can be replaced with analogous hardware components implemented within the specialized processor. In one embodiment, for example, the specialized silicon-based SQL processor can include an I/O handling component and a SQL parsing component, which can interact with a software-based protocol interface component and a calculation engine component. In another embodiment, a protocol interface component, a SQL parsing component, a calculation engine component, and an I/O handling component can all be implemented within a silicon SQL processor. A software-to-hardware interface, such as an Application Programming Interface (API) or an Application Binary Interface (ABI), can be provided to interface with database components implemented within the silicon SQL processor.

The present invention can be implemented in accordance with numerous aspect consistent with material presented herein. For example, one aspect of the present solution can include a SQL coprocessor. The SQL coprocessor can comprise silicon-based logic within which a set of machine-readable instructions that are associated with at least one silicon-based component of a database architecture can be implemented. A silicon-based component can be one of a group including a protocol interface component, a SQL parsing component, a calculation engine component, and an I/O handling component.

Still another aspect of the present invention can include a method for improving the speeds of SQL transactions. The method can include providing a silicon SQL processor that contains silicon-based logic within which a set of machine-readable instructions that are associated with at least one silicon-based component of a database architecture can be implemented. The provided SQL processor can receive a SQL request. The receipt of such a request can cause the SQL processor to perform a SQL transaction that is related to the request. A result for the SQL request can then be generated.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (prior art) is a schematic diagram illustrating a system for a mobile device solution that provides enhances user control for outgoing data in accordance with embodiments of the inventive arrangements disclosed herein.

FIG. 2 is a schematic diagram illustrating a system utilizing a SQL processor in accordance with an embodiment of the inventive arrangements disclosed herein.

FIG. 3 is a set of diagrams that illustrate configurations utilizing a SQL processor in accordance with an embodiment of the inventive arrangements disclosed herein.

FIG. 4 is a flow chart of a method 400 for utilizing a dedicated SQL processor to perform SQL transactions in accordance with an embodiment of the inventive arrangements disclosed herein.

FIG. 5 is a flow chart of a method for translating a software-based database component into a hardware components of a SQL processor in accordance with an embodiment of the inventive arrangements disclosed herein.

### DETAILED DESCRIPTION OF THE INVENTION

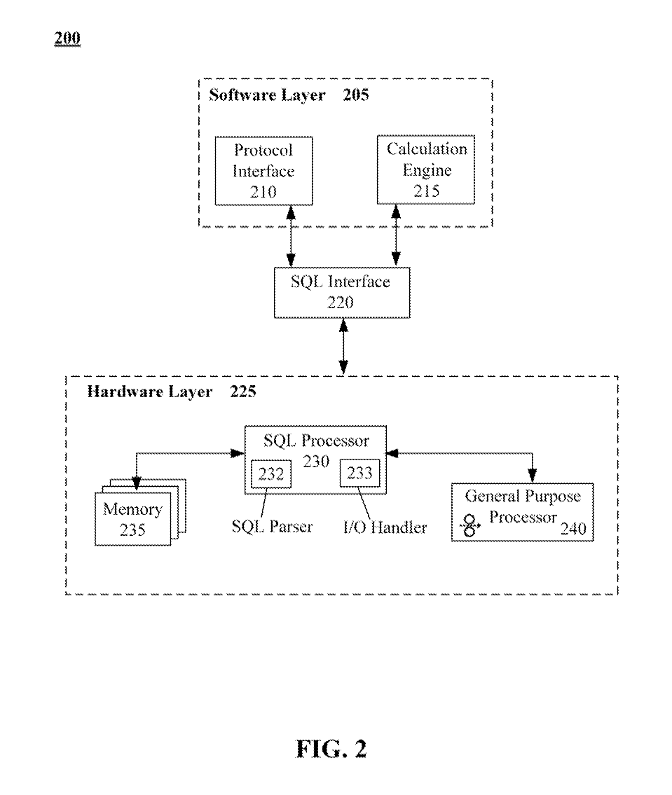

FIG. 2 is a schematic diagram illustrating a database architecture 200 utilizing a SQL processor in accordance with an embodiment of the inventive arrangements disclosed herein. This system 200 can be a replacement to or an enhancement to architecture 100 or any other existing database architecture that executes SQL commands.

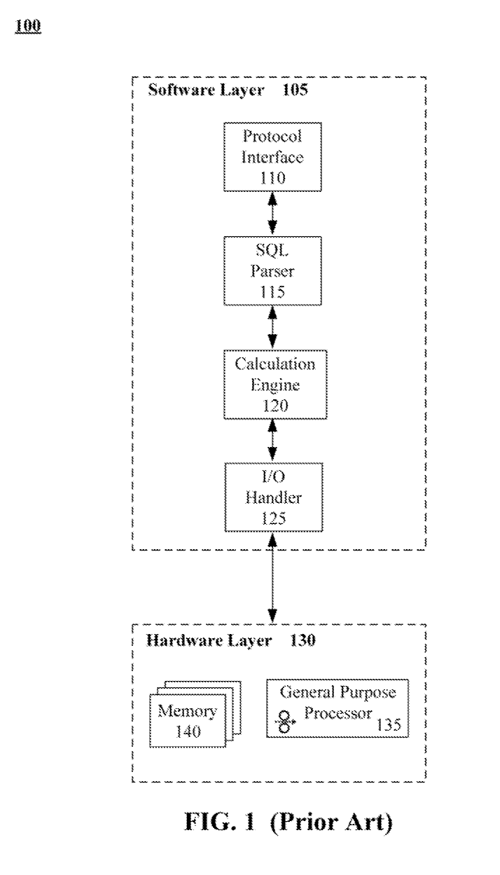

Like architecture 100 of FIG. 1, architecture 200 can contain a software layer 205 and a hardware layer 225. Unlike FIG. 1, communication between the layers 205 and 225 of architecture 200 can be handled by a SQL interface 220. This interface 220 can be standardized through the use of an application program interface (API) or an application binary interface (ABI). The interface 220 can act as an intermediary for the performance of SQL transactions.

Similar to architecture 100, this architecture 200 can include a protocol interface 210 and calculation engine 215 in the software layer 205. The protocol interface 210 can represent the means by which other applications and/or programming languages request the execution of SQL transactions. The calculation engine 215 can be a component that performs low-level operations for performing SQL transactions, such as lambda calculus. These components 210 and 215 can represent elements already existing in a RDBMS engine.

The hardware layer 225 can contain a SQL processor 230, memory 235, and a general purpose processor 240. The SQL processor 230 can be a silicon-based processor containing the logic necessary for performing SQL transactions. Further, the SQL processor 230 can include a SQL parser 232 and an I/O handler 233. The SQL parser 232 can parse a received SQL request into small commands that can be passed to the general purpose processor 240. The I/O handler 233 can access and/or store data in memory 235 needed to perform the SQL transaction. The general purpose processor 240 can represent a typical central processing unit (CPU) used in computing devices.

It should be appreciated that this system configuration can be advantageous in terms of processing speed. By moving the SQL processing components into hardware, the protocol interface 210 and the calculation engine 215 can operate in parallel, as opposed to the linear flow of architecture 100. Thus, SQL transaction can be processed concurrently, which can produce a significantly shorter processing time than when following a linear flow.

It should also be appreciated that including the SQL parse 232 component and the I/O handler 233 component within the hardware SQL processor 230 is one specific embodiment of the present invention, which generally discloses a concept of moving SQL components traditionally implemented in software to hardware to improve performance. System 200 illustrates an embodiment where different interacting SQL component layers communicate with each other across a hardware/software boundary.

Any combination of traditionally software implemented SQL components can be implemented in the SQL processor 230 and are to be considered within the scope of the present invention. For example, one or more (which includes all) of the protocol interface component 210, the SQL parsing component 232, the calculation engine component 215, and/or the I/O handler component 233 can be implemented in processor 230. Additionally, although SQL processing is categorized herein as occurring within different distinct component (e.g., protocol interface component, SQL parsing component, calculation engine component, I/O handler component) other decompositions of SQL functionality are contemplated, each of which can be implemented within an SQL processor 230. Further, although shown as implemented in the same hardware processor 230, different hardware processors can be used to implement different SQL processing components, such as a different processor for the SQL parser 232 and the I/O handler.

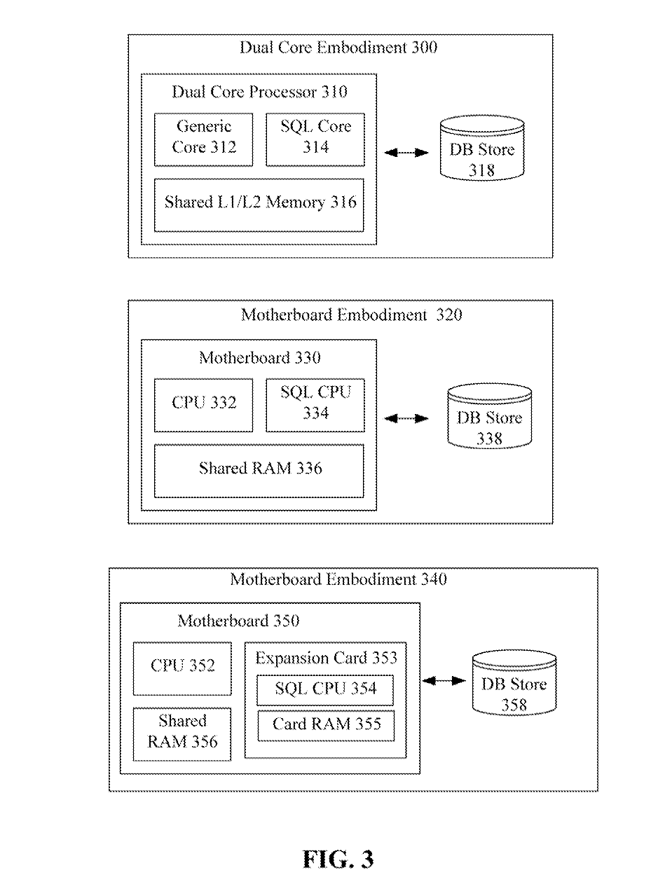

FIG. 3 is a set of diagrams 300, 320, and 340 that illustrate configurations utilizing a SQL processor in accordance with an embodiment of the inventive arrangements disclosed herein. The configurations shown in diagrams 300, 320, and 340 can be performed within the context of architecture 200 or any other database architecture utilizing a processor dedicated to performing SQL transactions.

Diagram 300 illustrates a dual core embodiment. This dual core embodiment 300 can include a dual core processor 310 that can access a database store 318. Further, the dual core processor 310 can consist of a generic core 312, SQL core 314, and shared Level 1 (L1) and/or Level 2 (L2) memory 316. A similar contemplated configuration (not shown) can implement SQL processing functions in a dedicated portion of a general purpose processor, which need not be a distinct processing core.

Diagram 320 illustrates a motherboard embodiment. The motherboard embodiment 320 can include a CPU 332, a SQL CPU 334, and shared RAM 336 located on a motherboard 330. When performing SQL transactions, the SQL CPU 334 can access a database store 338.

Diagram 340 illustrates an alternate motherboard embodiment. In this motherboard embodiment 340, the SQL CPU 354 can be incorporated on an expansion card 353 that can be added to a motherboard 350. The expansion card 353 can also include RAM 355 for use by the SQL CPU 354. Additionally, the motherboard 350 can contain a general purpose CPU 352 and shared RAM 356. When performing SQL transactions, the SQL CPU 353 can access a database store 358.

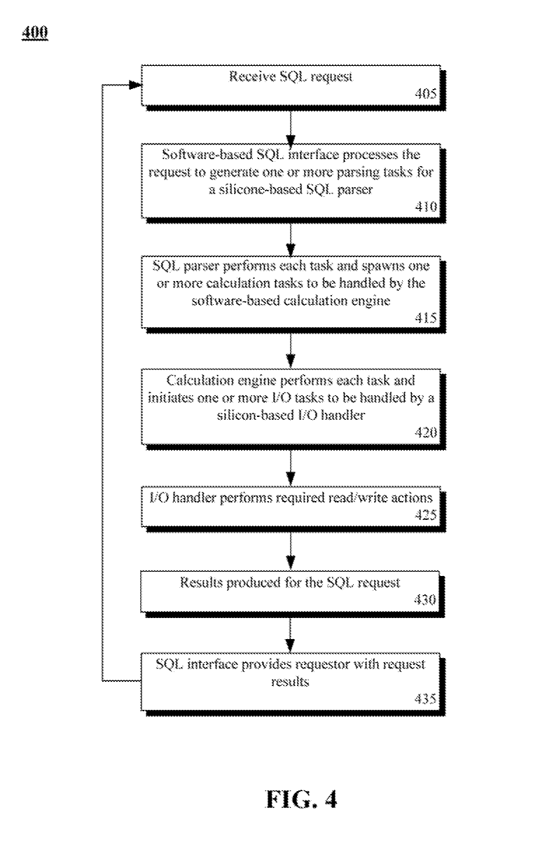

FIG. 4 is a flow chart of a method 400 for utilizing a dedicated SQL processor to perform SQL transactions in accordance with an embodiment of the inventive arrangements disclosed herein. Method 400 is designed for the implementation of hardware SQL processing for the components shown in system 200. It should be appreciated that derivative methods are contemplated for other implementations, such as when different SQL components (other than the SQL parse and I/O handler) are implemented in hardware.

Method 400 can begin when a protocol interface received a SQL request in step 450. In step 410, a software-based SQL interface can process the request to generate one or more parsing tasks for a SQL parser that can be contained within a silicon-based SQL processor. The SQL parser can perform each task and can spawn one or more calculation tasks to be handled by a software-based calculation engine in step 315.

In step 420, the calculation engine can perform each task and initiate one or more I/O task to be handled by an I/O handler that can be contained within a silicon-based SQL processor. The I/O handler can perform the required read/write actions in step 425.

Results for the SQL request can be produced in step 430. In step 435, the SQL interface can provide the requestor with the results. The method 400 can reiterate for every SQL request received, with flow a returning to step 405.

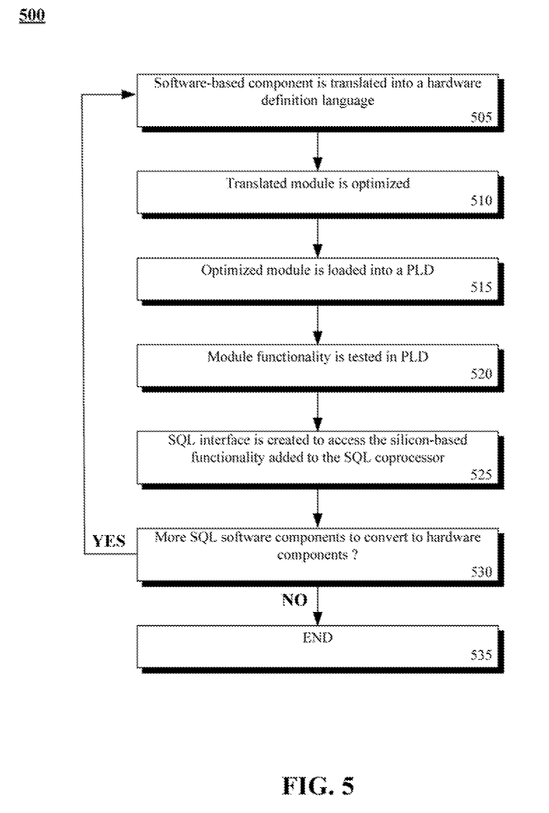

FIG. 5 is a flow chart of a method 500 for translating a software-based database component into a hardware component of a SQL processor in accordance with an embodiment of the inventive arrangements disclosed herein. Method 500 can produce a processor that can be used within architecture 200, the embodiments of FIG. 3, and/or execute method 400.

Method 500 can begin with step 505 in which a software-based component can be translated into a hardware definition language, such as VERILOG, VHDL, or SYSTEMC. The software-based component can represent code that performs lexical parsing, relational lambda calculus handling, and/or data structure mapping. Next, the translated module can be optimized in step 510. Optimization can be achieved in a variety of models, such as Register Transistor Logic (RTL) or the Transaction Level Model (TLM).

The optimized module can then be loaded into a Programmable Logic Device (PLD) in step 515. In step 520, the module's functionality can be tested. A SQL interface can be created to access the silicon-based functionality added to the SQL coprocessor in step 525. In step 530, it can be determined if there are more SQL software components to be converted to hardware components.

When no additional software components require translating, the method 500 terminates at step 535. The need to translate additional software components can cause the method 500 to reiterate, returning to step 505.

The present invention may be realized in hardware, software, or a combination of hardware and software. The present invention may be realized in a centralized fashion one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) a conversion to another language, code or notation; b) reproduction in a different material form.

What is claimed is:

1. A SQL coprocessor comprising:
silicon-based logic within which a set of machine-readable instructions associated with at least one silicon-based component of a database architecture is implemented, said silicon-based component comprising at least one component selected from a group of components consisting of a protocol interface component, a SQL parsing component, a calculation engine component, and an I/O handling component.

2. The coprocessor of claim 1, wherein at least one of the group of components is a software-based component including software-encoded machine-readable instructions that consume processing cycles of a generic processor, wherein the silicon-based component executes machine-readable instructions that consume processing cycles of the silicon-based processor.

3. The coprocessor of claim 2, wherein a standard interface is used to exchange information between the software-based component and the silicon-based component, wherein the standard interface is at least one of an application program interface (API) and an application binary interface (ABI).

4. The coprocessor of claim 1, wherein the at least one silicon-based component includes an I/O handling component.

5. The coprocessor of claim 1, wherein the at least one silicon-based component includes a SQL parsing component.

6. The coprocessor of claim 1, wherein the at least one silicon-based component includes an I/O handling component and a SQL parsing component.

7. The coprocessor of claim 6, wherein a protocol interface component and the calculation engine component that interacts with the silicon-based component of claim 6 are software components.

8. The coprocessor of claim 1, wherein said at least one silicon-based component comprises at least two components selected from a group of components consisting of a protocol interface component, a SQL parsing component, a calculation engine component, and an I/O handling component.

9. The coprocessor of claim 1, wherein said at least one silicon-based component comprises at least three components selected from a group of components consisting of a protocol interface component, a SQL parsing component, a calculation engine component, and an I/O handling component.

10. The coprocessor claim 1, wherein the SQL coprocessor is a specialized portion of a generic processor.

11. The coprocessor of claim 10, wherein the generic processor includes a plurality of cores, said SQL coprocessor being implemented in a dedicated one the cores.

12. The coprocessor of claim 1, wherein the SQL coprocessor is a distinct processor connected directly to a motherboard to which a generic processor is connected.

13. The coprocessor of claim 1, wherein the SQL coprocessor is a distinct processor located within an expansion card, which is connected to a motherboard to which a generic processor is connected.

14. A method for improving speeds of SQL transactions comprising:
providing a silicon SQL processor that includes silicon-based logic within which a set of machine-readable instructions associated with at least one silicon-based component of a database architecture is implemented, said silicon-based component comprising at least one component selected from a group of components consisting of a protocol interface component, a SQL parsing component, a calculation engine component, and an I/O handling component:
receiving a SQL request;
performing at least one SQL transaction related to the SQL request, said SQL transaction utilizing the silicon SQL processor and the silicon-based logic; and
generating a result for the SQL request.

15. The method of claim 14, wherein the at least one of the group of components is a software-based component implemented in software, said method further comprising:
the software-based component executing software encoded machine-readable instructions that consume processing cycles of a generic processor;
the silicon-based component executing the machine-readable instructions that consume processing cycles of the silicon-based processor.

16. The method of claim 15, further comprising:
utilizing a standard interface to exchange information between the software-based component and the silicon-based component, wherein the standard interface is at least one of an application program interface (API) and an application binary interface (ABI).

17. The method of claim 15, wherein the silicon SQL processor is concurrently utilized by a plurality of different RDBMS engines, wherein each of the different RDBMS engines includes an engine-specific software-based component, which one component of the group of components.

18. The method of claim 15, wherein said at least one silicon-based component comprises at least two components selected from a group of components consisting of a protocol interface components, a SQL parsing component, a calculation engine component, and an I/O handling component.

19. The method of claim 15, wherein said at least one silicon-based component includes a SQL parsing component and an I/O handling component.

20. The of claim 14, wherein the steps of claim 1 are performed by at least one of a service agent and a computing device manipulated by the service agents, the steps being performed in response to a service request.
